(19) United States
(12) Patent Application Publication
(10) Pub. No.: US 2012/0060127 A1
(43) Pub. Date: Mar. 8, 2012

(54) Automatic orientation of items on a touch screen display utilizing hand direction

(75) Inventor: Tommi ILMONEN, Espoo (FI)

(73) Assignee: MULTITOUCH OY, Helsinki (FI)

(21) Appl. No.: 12/876,192

(22) Filed: Sep. 6, 2010

(51) Int. Cl. G06F 3/033; G06F 3/041

(52) U.S. Cl. 715/863; 345/173

(57) ABSTRACT

Method or orienting items on the display to a user are based on the direction of the user hand, or the user are disclosed. The method relies on detection of the direction of the users' hand and orienting the item at a selected orientation thereto. An aspect of the invention also includes methods of detecting users' position about a touch screen display

### FIELD OF THE INVENTION

The present invention relates generally to touch screen based user interface, and more particularly to detection of user hand direction and automatic orientation of documents to a selected orientation in interactive computing environments.

### BACKGROUND OF THE INVENTION

Touch screens are a growing area in the field of electronics and their most significant impact is in the field of user interfaces. Touch screen based user interface utilize a touch or proximity sensitive display based computing environment, wherein the environment is directed towards serving one or more users interacting with the computing environment via the display. The display may comprise one or more physical display devices, on which the users may view documents, enter computing commands by the like of gestures and pressing specific areas. Touch screen displays may take any desired shape, such as round, elliptical, polygonal, and the like, and may be oriented at any desired orientation such as horizontal, vertical or any angle in-between. In the context of tabletop computing, the term display shall be used hereinafter to denote the combination of the portion capable of actually displaying content, and the sensing surface coupled thereto.

Tabletop computers are computers that utilize a substantially horizontal surface on a table like form. The surface has a display that can sense a plurality of touches and use them to activate, navigate, create, and/or otherwise manipulate content. Such computing environments may be utilized for any common interactive computing needs, but are commonly used for entertainment, local and remote interaction between users, kiosks, presentations, and the like. Due to the ability to sense simultaneous multiple touch points, and the ability to accommodate concurrent multiple users, tabletop based computing have shown great promise for facilitating group collaborative effort and interaction.

The content handled by the tabletop computer may be any content type commonly manageable by a computer, such as documents, images, video, drawings, maps, and the like. For brevity all such content will be referred hereinafter as ‘items’. Items further include “widgets’ (sometimes related to as ‘buttons’), which relate to areas of the display which cause an action to be taken when pressed or otherwise activated by the user. Widgets may be icons, instructions, text, and the like, which act to issue specific instruction to the computer responsive to a user touch. It is also common to utilize predetermined gestures to input instructions into the computer.

Many items of interest have a desired orientation. The desired orientation defines a surface direction in which the item is interpreted as being oriented “upwards” for ‘correct’ viewing by a user if the item was displayed on a vertical surface. The desired orientation may be ‘natural, or assigned. By way of example, the natural orientation of an outdoor vista image will be an orientation which shows the sky up, and the land down, but a user may wish to assign another orientation, for example for aesthetic reasons, or to enhance a specific feature.

While on a vertical display surface the “up” direction is commonly shared by all viewers, in a substantially horizontal display environment such as the tabletop computer, especially where a plurality of users may occupy different positions about the table, the “up” direction is subjective, and the direction may change for each user. Therefore to increase usability, it is desired to orient items towards a specific user such that the item is displayed in the proper orientation when the user activates an item, or when an item is handed to him/her.

Clearly, a simple solution to the problem would be to allow each user to manually orient the item as s/he desires. However this solution is less than optimal. Users expect the computer to automate such activities so as to achieve better integration at human/machine interface, and the need for manual orientation of the item distracts the users from producing efficient work.

Several attempts have been made to automatically orient the item towards a specific user. In “Visualizing and Manipulating Automatic Document Orientation Methods Using Vector Fields”, Pierre Dragicevic and Yuanchun Shi, (ACM International Conference on Interactive Tabletops and Surfaces, Nov. 23-25, 2009, Banff, Alberta, Canada, Copyright © 2009 978-1-60558-733-2/09/11) Dragicevic et al. attempted to provide automatic orientation by defining “orientation fields”, which are vector defined fields or regions on the tabletop, and setting the orientation in accordance with those predefined regions. In “Search on surfaces: Exploring the potential of interactive tabletops for collaborative search tasks” (Information Processing and Management (2009), doi:10.1016/j.ipm.2009.10.004, Microsoft Corp.) Morris, M. R., et al. proposed utilizing a plurality of keyboards located on the tabletop and orientation of items relative to the keyboards. In a few short sentences in this paper the authors summed up their view of the state of the art: “Orientation is a perennial challenge for tabletop displays (Shen, Vernier, Forlines, & Ringel, 2004), since content that is right-side-up for one user is upside-down for anyone seated across the table. Some automated solutions are possible, including lazy-susan-style Uls (Shen et al., 2004), replication of content for all users (Morris, Paepcke, Winograd, & Stamberger, 2006), “magnetization” of the UI in one direction at a time (Shen et al., 2004), and affordances for manually re-orienting content (Shen et al., 2004). Orientation issues become particularly critical during collaborative search tasks, as search often involves dealing with large amounts of textual data, and dense text is particularly orientation-sensitive (Wigdor & Balakrishnan, 2005) . . .

. . . As we have described, current tabletop technologies' limitations regarding text entry, clutter, and orientation can make it particularly challenging to adapt these technologies to productivity tasks (Benko et al., 2009; Morris, Brush, & Meyers, 2008); however, with continued advances in hardware and software from the tabletop community, as well as careful application design by the search community, these challenges can be overcome. In the next section, we describe four applications that illustrate several approaches to addressing these issues.” (Emphasis added)

As will be apparent from the above, the common wisdom in this field relies upon either reorienting the whole workspace in a specific direction, which does not fit the requirements of all users at the same time, duplication of information, and generally partitioning the tabletop display surface and orienting the item relative to the location thereof. Clearly methods for auto orientation which are based on location of the item are lacking as they require partitioning of the display area, which limits the usability and flexibility of the surface computing interface.

Thus there is a heretofore unfulfilled need for an improved method of automatically orienting items towards a user in a surface computing user interface. Furthermore It will be advantageous to identify or approximate the location of a user about a tabletop.

### SUMMARY OF THE INVENTION

One aspect of the present invention is aimed at providing a method of orienting an item towards the user in a manner that will overcome the limitations of the prior art by detecting the direction of the user about the table. This is carried out by determining the orientation of the user hand or hands.

For the purpose of these specifications, the term ‘multi-touch’ is directed to surfaces capable of detecting a plurality of ‘touch points’, which includes actual touches, as well as proximity, to the sensing surface. Several methods of providing multi-touch capabilities are known in the art and include by way of non-limiting examples antennae embedded in the sensing surface, capacitive and inductive interaction between the touching body and the surface, and utilization of cameras and computer vision. The term ‘touch’ is used colloquially to indicate an actual touch or a sufficient proximity of the touching body to the sensing surface, which will be detected and perceived by the system as equivalent to an actual touch.

The term tabletop computing should be construed to include all computing environments which accommodate a plurality of simultaneous touch points to interactively activate and manipulate electronic content and the display thereof. The plurality of touch points may be from one or more users.

Orienting an item towards a user should be construed to orient the item in a manner where the direction that would be perceived as “up” when displayed on a vertical display, would point away from the user relative to the table. To that end, there is defined an orientation vector, which defines the item ‘up’ direction. Thus, by way of example, in a document simulating a page of English text, the orientation vector would normally be oriented orthogonal to the text, and pointing towards the first line to be read, and where the text would be read from left to right. In another example, an image of a building would have the orientation vector point from the center of the building towards the roof, and the like. It is noted however that items may be purposefully accorded any desired orientation vector which does not conform to the 'up direction, if it is desired that the item be displayed so as to have an up direction different from the common.

The term ‘orientation vector’ will be used in these specifications to indicate the direction in which an item should be displayed to a user in a manner perceived by, or intended to be perceived by, the user, as pointing the item up. Clearly, the ‘up’ orientation is arbitrarily selected, and the skilled in the art will recognize that the orientation vector may be directed to define any desired orientation and a simple rotation transformation may be applied to the item to obtain similar results as described herein. However, for ease of understanding, the orientation vector will be perceived as the direction of the item portion that will point away from the user relative to the table when the item is oriented towards a user. It is noted that the item may be oriented at an angle different from directly up, and allows aligning the item to a selected angle relative to the user or the table, such as aligning the item to an absolute axis of the table, aligning according to user preference or program control, and the like.

Thus there is provided a method for automatic orientation of a displayed item having at least one orientation vector τ, towards a user. The user operates in a computing environment having a touch capable display. The method comprises the steps of identifying a user hand touch or gesture, when such touch or gesture is affected by the user on the display, so as to cause the computer to take a predetermined action associated with the touch or gesture; responsive to the hand touch or gesture, determining a hand direction \vec{η}, the hand direction having pre-defined relationship to the location of the user; and automatically orienting the item to the user by aligning the item in a predetermined relation between the hand direction \vec{η} and the orientation vector τ of the item.

Preferably, the touch display is a computer vision based system, which comprises a camera located to provide an image of the display surface. In such embodiment, the step of determining the hand orientation direction comprises detecting a plurality of finger touch points, either by direct touch data or by image recognition, detecting the location of a palm attached to the fingers by utilizing image recognition, and determining finger vectors between at least one finger and a point under the palm. The hand direction \vec{η} is then computed by vector extending from a point on the palm towards the finger. Preferably more than one finger is detected and the vectors between the fingers and the palms are summed, resulting in a hand direction. In the specific case of identifying a thumb, special weight is given to the thumb vector, as described below.

Optionally, the display is divided to a plurality of cardinal sectors, and the predetermined relationship between the hand direction \vec{η} and the orientation vector τ of the item comprises orienting the document in parallel to one the cardinal directions.

In another aspect of the invention there is provided a method for automatic orientation of an item having an orientation vector τ, towards a user, where the item has a ‘widget’ associated therewith. The user operates in a surface computing environment having a touch capable display. The method comprises the steps of identifying a user hand touch or gesture, when such touch or gesture is affected by the user on the display, at a location associated with the widget so as to cause the computer to take a predetermined action associated with the touch or gesture. The predetermined action may be, by way of example, opening an item, enlarging or contracting an item, moving an item, and the like. Responsive to the hand touch or gesture, determining a hand direction \vec{η}, the hand direction having pre-defined relationship to the location of the arm; performing the action associated with the button, and automatically orienting the item to the user by aligning the item in a predetermined relation between the hand orientation direction η and the orientation vector τ of the item.

Another aspect of the present invention is directed towards estimating the position of a user relative to a touch capable display. The method comprises the steps of identifying a user hand touch on the display, the touch comprising sufficient data to determine the direction of the hand by any of the techniques describes hereinafter; identifying a convergence point associated with the user palm attached to the plurality of fingers; calculating a plurality of vectors from the convergence point to the corresponding plurality of the fingers; summing the plurality of vectors to receive a hand direction \vec{η} approximating a relationship between the location of the user relative to the convergence point. The convergence point may be derived utilizing geometrical methods or by detecting the location of the user palm utilizing image recognition, and deriving a convergence point which lies therein. More preferably, the method comprises deriving hand direction \vec{η} for a left and a right hand, and estimating the direction of the user as the direction of an altitude of a triangle as measured from a vertex at the intersection of the hand direction of the two hands.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a desktop display system operable in accordance with the preferred embodiment of the present invention.

FIG. 2a depicts graphically two user hands touching the screen, and FIG. 2b depicts only the touch points pattern sensed by the sensing surface

FIG. 3 depicts the finger touch points of one hand, and vectors drawn to a convergence point.

FIG. 4 depicts derivation of a user direction vector.

FIG. 5 is a picture exemplifying the view a camera placed in a tabletop display sees when a user hand touches the display.

FIG. 6 is a simplified flow diagram showing a method of detection of the hand direction.

FIG. 7 is a simplified flow diagram showing a method for selection of a convergence point.

### DETAILED DESCRIPTION

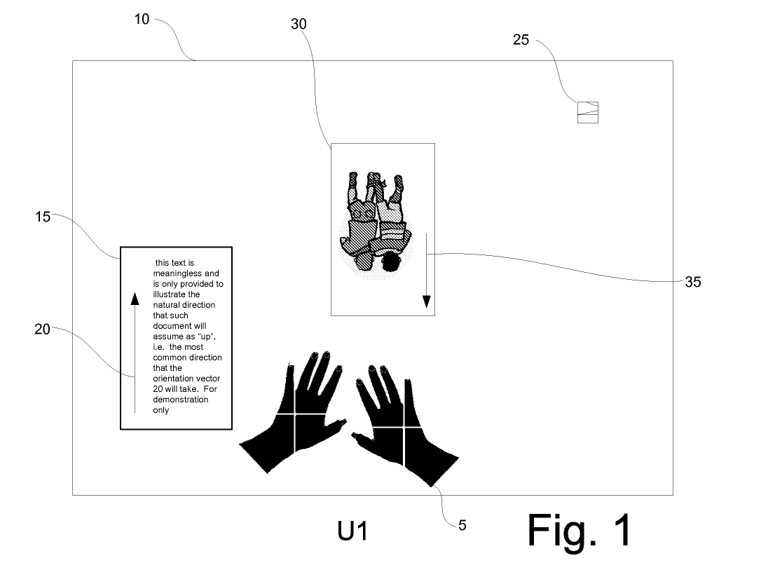

FIG. 1 depicts a common tabletop display 10 as an environment in which the present invention may operate. A user location is denoted as “U1” and the user hands 5 are depicted symbolically on the desktop. It is noted that in natural orientation, the hands will be substantially pointing at the same direction as the arm or at a slight angle thereto. The computer (not shown) displays an item 15 which depicts a text document with its orientation vector 20. Similarly image item 30 has an orientation vector 35 which points at the user U1. If the user U1 take action to view or otherwise manipulate the item 30, it will be desired to rotate the document so that the orientation vector will point generally away from the user. The desktop further depicts a widget 25. Widget 25 may be a pre-designated area, an icon, a small image of a larger document, a text segment, and the like. Pressing the widget shall instruct the computer to take a specific action, such as opening an item or items associated with the widget, orienting all or segments of the tabletop display towards the user, creating a blank item for the user to fill with content, and the like. Each of those actions would benefit from knowing the location of the user, so as to open the item, or direct the tabletop orientation towards the user.

According to the preferred embodiment, the orientation of the user hand or hands is utilized to decide the orientation of the item. While manual manipulation stays as a viable option for the user, the preferred embodiment will respond to a specific gesture, which will cause a computer to orient the item in a predetermined relationship to the direction of the user as perceived by the detection of the hand and its orientation.

Touch sensitive displays may be coarsely divided into vision based display and touch based display.

Vision based displays are based on a camera identifying objects touching the display. A common technology embodying such vision based technology is known is FTIR (Frustrated Total Internal Reflection). Another example of vision based display is commercially available from MultiTouch, a company based in Helsinki, Finland, under the commercial names MultiTouch Cell or MultiTouch box. The technology that allows such image recognition is described in PCT patent application publications No. WO2010023348 and WO2010023358, to the present inventor, which are incorporated herein in their entirety by reference.

Touch based displays are, as the name implies, based on detecting a touch on the screen. By way of example, capacitive and resistive displays are well known, as well as a plurality of others like infra-red grid type displays, strain gage based displays, and the like. Generally while vision based touch sensitive display can identify the palm by image analysis, touch based displays require the use of computational heuristics as will be explained below.

An embodiment of the present invention utilizes vision based displays and image recognition. Image recognition is a well known field of computing wherein computers are utilized to identify certain objects. In most cases image recognition operates by edge recognition, movement detection and the like. Many vision based touch sensitive displays allow identification of hands, including separation between fingers and palms, and more importantly the association between a certain palm and the fingers belonging thereto. The skilled in the art will recognize that image processing techniques are well known in the art and identifying the palm and fingers may be carried out in a plurality of ways, the specific method being a matter of technical choice.

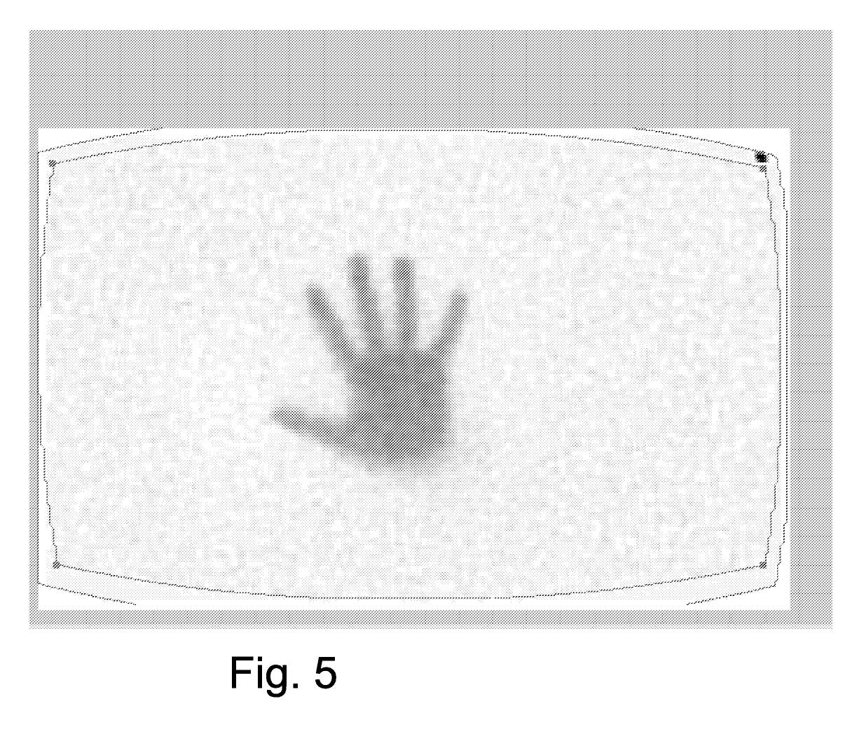

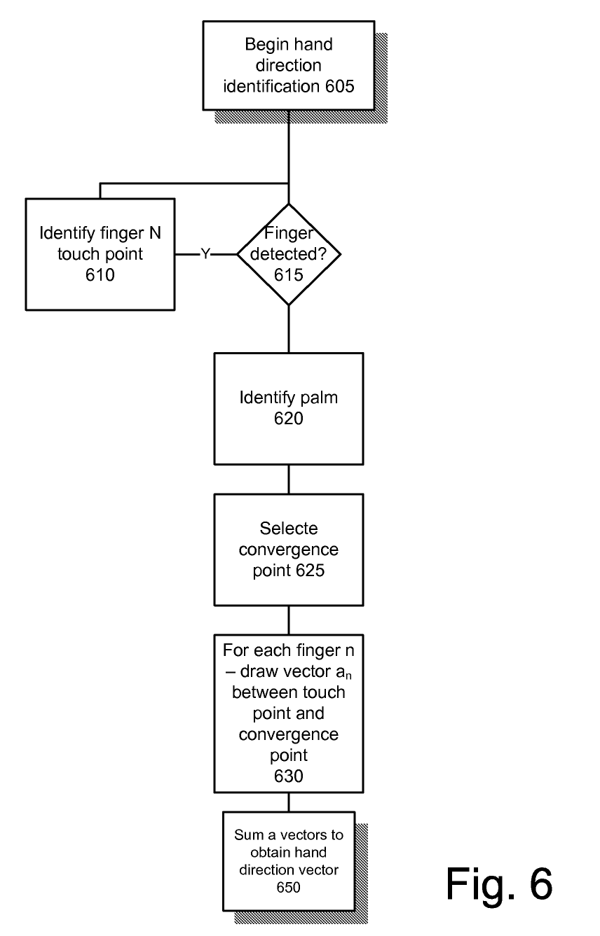

FIG. 5 is an example of the view received by a camera in a vision based display when a hand 510 touches the screen. The finger touch points 520, 525, 530, 535, and 540, as well as the thumb 545 are easily recognized and lend themselves easily to identification based on computer vision. Further seen are convergence points 560 and 570, which are added under the palm for illustration purposes. Convergence point 560 resides approximately under the center of the palm.

It is recognized that identifying the palm and its boundaries with reasonable accuracy is a matter well within the capability of the artisan skilled in computer vision. By way of non limiting example such identification may be carried out by edge tracing of a shape containing at least several of the touch points. Once the boundaries of the palm are identified, selecting a convergence point 560, 570 that falls within those boundaries may be done by estimating the geographic center of the palm, or by selecting a convergence point based on ergonometric factors such as at the center of the detected root of the hand, and the like.

When only a single finger is detected, say the index finger detected as touch point 520, computer vision may be used to divide the palm image and locate the convergence point 570 at an offset to the convergence point 570 about the center of the palm. Thus a single vector \vec{η} may be drawn between the index finger touch point 520 and the convergence point 570. The direction of the vector \vec{η} provides an estimation of the direction of the hand, and the direction of the hand allows estimation of the direction the user.

While the above is a simple embodiment of the aspect of the invention allowing identification of hand direction, it is open to significant error. A more accurate solution may be obtained as more fingers are detected, by drawing vectors between the detected fingers and the convergence point at the center of the palm 560. After the vectors are drawn, they are summed to receive the hand direction vector \vec{η}, as will be discussed below. It is noted however that for vision based displays, only a single finger and the palm is required, and two or more finger detection provides additional accuracy by summation of the vectors associated with such fingers. In contrast, touch based displays require detection of at least three fingers.

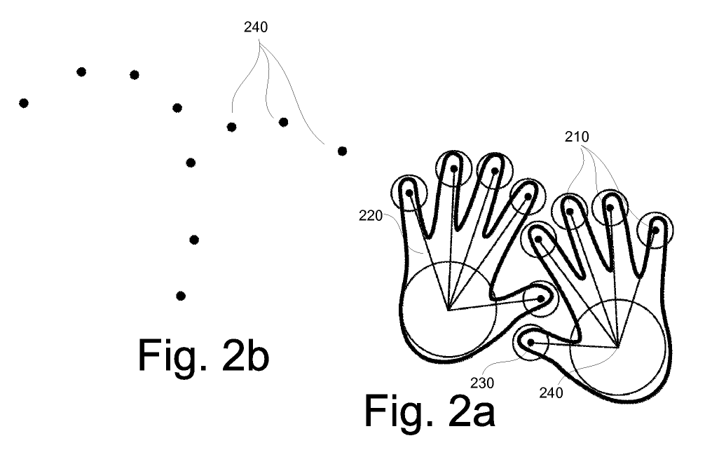

FIG. 2a depicts two user hands touching the screen, and FIG. 2b depicts only the touch points pattern sensed by the sensing surface resulting form the touch of 2a. The touch points 210 correlate to the sensed touch points 240. identification of the touch points as belonging to a hand may be deduced by utilizing certain heuristics, such as, by way of example, that the fingers are laid a manner forming an arc, and arc defined by points at a given proximity are assumed to be formed by a single hand. Alternative assumption may be made, and optionally a certain gesture may be required that will help identify the touch points of fingers of one hand. It will be recognized that the direction of the hand may be deduced by analyzing the touch points. By way of example, the location of a convergence point may be carried out by drawing an arc between any combination of three touch points belonging to the longer fingers, and drawing lines towards the arc centers, which provides an intersection point or an intersection area, which may be used as a convergence point which will lie under the palm in most natural postures. Clearly other geometrical methods may be equivalently used, and computing, utilizing well known principles, takes place of actual drawings and determining arc centers, line intersections, and the like.

While these methods are subject to errors due to different finger lengths, uneven finger placement and the like, they provide a basic embodiment of the invention that may be obtained by any multi touch capable technology, without the necessity to sense the palm location. Vectors, such as 220, are drawn between the corresponding touch points and the convergence point 240 and used as described below to derive a direction towards the user.

It is noted that the thumb touch point 230 is ignored in this embodiment. However the thumb may be utilized advantageously as explained below.

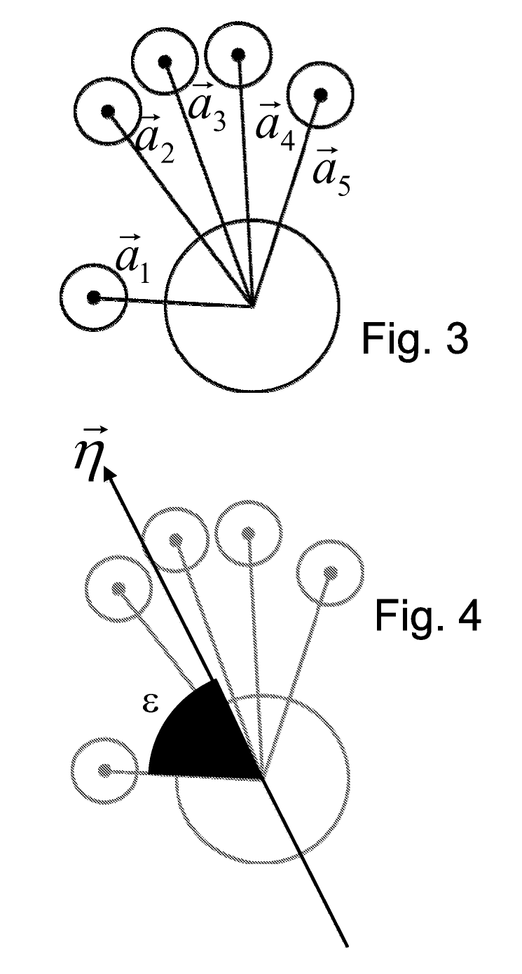

FIG. 3, which is applicable to both vision based or touch based systems, depicts the finger vectors a1, a2, a3, a4, and a5. Vectors a2-a5 extend from the convergence point to the longer fingers, and vector a1 extends from the convergence point to the thumb. It will be recognized that the direction selection is arbitrary and mathematically extending the vectors in the opposite way allows fully equivalent, if opposite result.

FIG. 4 shows schematically how the hand direction is derived by summation of vector fingers. While the example and formula below shows five fingers, smaller number may be used, as explained above. The hand direction \vec{η} vector may be derived by the following formula

$$\vec{η} = \{ \frac{1}{n} {\sum }_{i = 2}^{n} {\vec{a}}_{i} \} + k {\vec{a}}_{1}$$

wherein n is the number of fingers detected. It is noted that the thumb vector \vec{a}₁ is preferably handled differently than the rest of the fingers as it is assumed to be shorter and with a largely varied angle ε between a1 and \vec{η}, as compared to the rest of the fingers. Thus a certain assumed weighing factor k is applied to the thumb vector. Alternatively, the thumb may be ignored.

In natural postures, the hand direction \vec{η} is assumed to be equivalent to the arm direction, or may have an assumed offset. The direction is often at an acute angle with a line drawn between the users' shoulders. In order to improve the accuracy of estimating the user location relative to the table the direction of tow hands may be utilized, in which case user direction from the touch points may be approximated as the altitude of a triangle from the vertex formed at the intersection of the hand direction vectors \vec{η} of the right and left hands.

FIG. 6 is a flow diagram for vision based detection of the hand direction. The process begins 605 by detecting at least one finger touch 615 and identifying it as such, including identifying 610 the precise location that will be considered as the touch point, aiming sure the touch is indeed valid, and in certain cases, after the first finger is identified, determining if the finger belongs to the same hand associated with previous fingers. The identification may further include determining if the finger touch is a thumb. This process repeats until no more fingers of the same hand are detected.

While the step of detecting the palm 620 appears after the fingers, and most commonly occurs after such touch detection, the process may occur at any desired time, even before the finger touch points detection and determination. The selection of the convergence point 625 may be carried out by a variety of methods, such as finding the geometrical center of the palm, locating arc centers of the arcs formed by the fingers as explained above, offset to match one finger or any other method that would provide sufficient directional accuracy. By way of example, if the item is to be aligned to cardinal directions, only an accuracy equal to within the difference between cardinal direction is required. If on the other hand the detection of the hand or user direction is utilized as a game control system, often the required accuracy is smaller than one degree.

Drawing 630 of the finger vectors from individual fingers to the convergence point and the summation of the fingers will be clear to the skilled artisan.

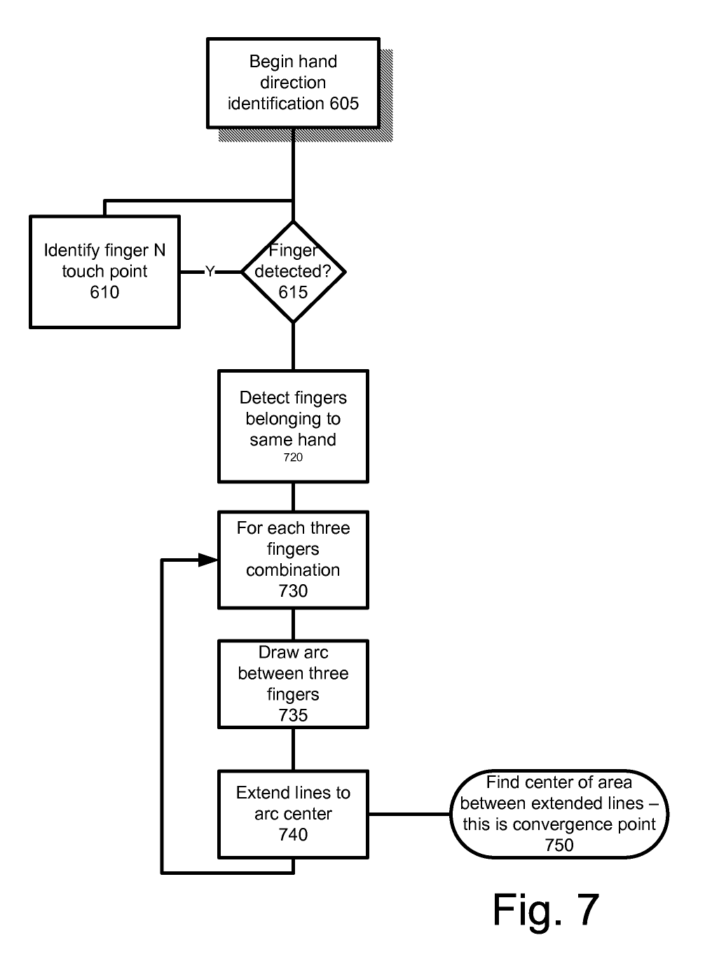

FIG. 7 describes an example method for locating a convergence point without requiring detection of the palm. The steps 605, 610, and 615 are similar to the ones described above. The verification 720 that the detected fingers belong to a single hand, or the identification that another hand is involved, is carried out using certain assumptions. By way of example, the verification may be made by placing a proximity restriction between the fingers, and a requirement that a certain number of fingers would lie in an arc. If the steps described below for convergence point are carried out, the location of the convergence point relative to the finger tips can also be used as a heuristic for bolstering the logic that the detected fingers do belong to one hand.

The specific method of detecting of the convergence point depends on the capabilities of the specific display technology involved. One method that requires no more than the touch points of at least three fingers is described. For each of the possible three fingers combinations 730, an arc is drawn 735 between the fingers, and lines are extended 740 between the each finger touch point and the arc center. If four fingers are detected, four such combinations exist: 1) index, middle, and ring fingers, 2) index, ring, and little fingers, 3) middle, ring, and little fingers, 4) index, middle and little fingers. The lines extended from the fingers to the arc centers define an area and a geometrical average may be taken and defined as convergence point.

Approximating the direction of the user relative to a base coordinate system of the tabletop display may be desired, and would be a matter of applying common geometrical methods. By way of example, either the user direction (coming from two hands) or the hand direction may be used. If the hand direction is used, it is assigned a magnitude extending from the convergence point, to the edge of the display along the hand direction. in the case of user direction, as derived by two hands, the magnitude may be assigned from a midpoint between the two convergence points, to the edge of the display along the user direction, to receive a user vector. The user position relative to the base point of the tabletop may be obtained by summing the user vector with a vector extending from the display coordinate base to the convergence point or the midpoint respectively.

While the detection of the user location around the tabletop may be estimated with significant accuracy, it may be desired to orient the items to a direction other than the precise direction between the center of the table and the user. By way of example, a number of cardinal directions such as four directions separated by 90 degrees, 8 directions separated by 45 degrees, and the like may be utilized, and the document may be aligned to one of those cardinal directions, either along the cardinal direction, or along a line parallel thereto. Thus for example, if the user is situated along the 30 degrees radial from the center of the tabletop (the 0 degrees being arbitrarily defined as being at 90 degrees to a straight edge of the tabletop), it may be desirable to align the items to the 0 degrees vector, if desired. Doing so may be selected by the user or as a choice of the operating system, an environment variable, and the like.

One special circumstances is when an item is first opened, where it is clearly advantageous to orient the item towards the user that opened the item. Detection of the user's location may provide not only the orientation in which the document will open, but may also dictate the location on the tabletop in which the document will open, so as to provide the most convenient usage. Thus by way of example, if the user position about the table is detected by the hand direction, the document can be opened near the tabletop edge near the user, with the right orientation.

It is further noted that while tabletop computing is one of the most obvious beneficiaries of the various aspects described herein, other devices such as cellular telephones, electronic reader, tablet based computers, games, and the like may benefit from the invention or certain aspects thereof, and the embodiment of the teachings, techniques, and teachings, provided herein should be considered equivalent to their applicability to such devices. Thus the invention and the appended claims seek to cover the invention as it is applied to such equivalents to the tabletop described herein. Furthermore, one or more of the hand direction detection methods described herein may be beneficially utilized for other applications such as game controls, robotic arm controls, and the like.

It is noted that tabletop computer surfaces may operate while tilted away from the horizontal plane. It is further noted that the display may be surrounded by an edge that does not comprise the display itself, but it is assumed that the display extends to such an edge.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

I claim:

1. A method of automatic orientation of an item having an orientation vector τ, towards a user operating in a surface computing environment having a multi-touch capable display, the method comprises the steps of:
Identifying a user hand touch or gesture affected by the user on the display, at a location associated with an item;
responsive to the hand touch or gesture, determining a hand orientation vector η;
orienting the item to the user by aligning the item in a predetermined relation between the hand orientation vector η and the orientation vector τ of the item.

2. The method as claimed in claim 1, wherein the multi-touch display comprises a computer vision based detection system, and wherein the step of determining the hand orientation direction comprises:
detecting a plurality of finger touch points;
detecting location of a palm attached to the fingers;
identifying which of the detected fingers belong to the detected palm;
determining a plurality of finger vectors between a corresponding plurality of fingers and a point under the palm;
summing the finger vectors to obtain hand orientation direction η.

3. The method as claimed in claim 1, wherein the multi-touch display comprises a computer vision detection system, and wherein the step of determining the hand orientation direction comprises:
detecting a single finger touch point;
detecting location of a palm attached to the finger;
determining a vector between the finger and a point under the palm.

4. The method as claimed in claim 3 the point under the palm is selected by finding the center of the palm, and selecting a point as an offset to the center of the palm, selected by the relative finger position in the hand.

5. The method as claimed in claim 1, further comprising the step determining if the finger touch points include a thumb touch point, and when a thumb touch point is detected, weighing the thumb vector more than any other detected finger.

6. The method as claimed in claim 1 wherein the display is divided to a plurality of cardinal sectors, and wherein the predetermined relationship between the hand orientation direction and the orientation direction of the item comprises orienting the document in parallel to one the cardinal directions.

7. A method of automatic orientation of an item having an orientation vector τ, towards a user operating in a surface computing environment having a multi-touch capable display, the item having a widget associate therewith, wherein the widget is further associated with performing a predetermined action on the item, the method comprises the steps of:
Identifying a user hand touch or gesture affected by the user on the display, at a location associated with the widget;
responsive to the hand touch or gesture, determining a hand orientation direction η, the hand orientation having pre-defined relationship to the location of the arm;
performing the predetermined action on the item; and,
orienting the item to the user by aligning the item in a predetermined relation between the hand orientation vector η and the orientation vector τ of the item.

8. The method as claimed in claim 7, wherein the multi-touch display comprises a computer vision based detection system, and wherein the step of determining the hand orientation direction comprises:
detecting a plurality of finger touch points;
detecting location of a palm attached to the fingers;
identifying which of the detected fingers belong to the detected palm;
determining a plurality of finger vectors between a corresponding plurality of fingers and a point under the palm;
summing the finger vectors to obtain hand orientation direction η.

9. A method of estimating a user location relative to a multi-touch capable display, the method comprises the steps of:
Identifying a user hand touch on the display, the touch comprising at least a plurality of touch points made by simultaneous touch of a plurality of fingers;
identifying a convergence point associated with the user palm attached to the plurality of fingers;
calculating a plurality of vectors from the convergence point to the corresponding plurality of the fingers;
summing the plurality of vectors to receive a user direction approximating the location of the user relative to the convergence point.

10. A method as claimed in claim 9 further comprising the step of translating the user direction relative to a display coordinate base, by assigning the user direction a magnitude extending from convergence point to the edge of the display along the user direction, to receive a user vector, and summing the user vector with a vector extending from the display coordinate base to the convergence point.

11. A method as claimed in claim 9 wherein the step of identifying the convergence point utilizes image recognition of the palm.
